(19) United States
(12) Patent Application Publication
(10) Pub. No.: US 2024/0294051 A1
(43) Pub. Date: Sep. 5, 2024

(54) CABINET SYSTEM FOR A VEHICLE

(71) Applicant: TRUMA GERAETETECHNIK GMBH & CO. KG, Putzbrunn (DE)

(72) Inventor: Mathias VENSCHOTT, Putzbrunn (DE)

(21) Appl. No.: 18/275,660

(22) PCT Filed: Dec. 17, 2021
(86) PCT No.: PCT/EP2021/000157

§ 371 Date: Aug. 3, 2023

(30) Foreign Application Priority Data
Mar. 26, 2021 (DE) 102021001595.9

(51) Int. Cl. B60H 1/00; B60P 3/36

(52) U.S. Cl. CPC B60H 1/00535; B60H 1/00364; B60P 3/36

(57) ABSTRACT

Example embodiments relate to a cabinet system for installation in a vehicle, including a lower receiving space, an upper receiving space and an electrical contacting device. The upper receiving space is configured such that an air conditioner can be reversibly inserted therein and that the air conditioner is mechanically reversibly fixed by a completed insertion and is reversibly contacted with the electrical contacting device.

### FIELD OF DISCLOSURE

The present disclosure relates to a cabinet system for installation in a vehicle. The vehicle is, for example, a caravan or mobile home.

### BACKGROUND

Caravans or mobile homes (both also collectively referred to as caravans) or, in general, all types of vehicles which have a movable living space, usually have temperature control devices such as heaters or air-conditioning systems. An air conditioning system with several configurations is disclosed, for example, in DE 20 2009 009 446 U1. Occasionally, air-conditioning systems are omitted and only a roof window is used for ventilation.

It has become widely established to provide a refrigerator if the caravan exceeds a certain size. One challenge of such refrigerators is that the refrigerator is not set too high so as to not make accessibility or reachability difficult for the user. For this reason, a storage compartment for utensils is usually left above the refrigerator.

Often, the request for an air-conditioning system arises only later during the use of a caravan. However, it then turns out to be a disadvantage that air-conditioning systems or air conditioners are complicated to install. For example, the device which provides the cooling circuit must be mechanically fixed and electrically connected. In addition, pipes and air distributors have to be installed, through which the room air for cooling and the outside air for exhausting the outside air are routed. The individual components are also associated with a generally high space requirement. The process of installation also increases costs, as it is preferably carried out by skilled personnel. Thus, the overall constraints to subsequently purchase an air-conditioning system increase.

A basic form for a cabinet system is disclosed in EP 3 121 042 B1, only the air routing of the air conditioner being however discussed.

The object of the present disclosure is to reduce the disadvantages in the prior art with respect to the assembly of air conditioners.

### SUMMARY

The present disclosure achieves the object by means of a cabinet system for installation in a vehicle, comprising a lower receiving space, an upper receiving space and at least one electrical contacting device for providing electrical power and/or for data communication, wherein the upper receiving space is configured such that an air conditioner can be reversibly inserted into the upper receiving space, and wherein the upper receiving space is configured such that the air conditioner is mechanically reversibly fixed in the upper receiving space by a completed insertion into the upper receiving space and is reversibly contacted with the electrical contacting device.

The present disclosure thus describes a cabinet system into which an air conditioner can be reversibly inserted. It is then possible that already by inserting the air conditioner, a fixation, i.e. a mechanical fixation, and an electrical contacting is accomplished. The installation of the air conditioner is thus simplified. In addition, an upper receiving space is used for the air conditioner, which in the prior art is usually only used as a storage space. Therefore, the space usually limited in the caravan is also optimally utilized. The great advantage is that the cabinet system virtually implements a rack system and that, for example, the user himself can slide the air conditioner unit in and out. Thus, there is no need for complicated assembly and it is easier for the user to opt for an air conditioner. The mechanical fixing is achieved, for example, by means of a latching system between the air conditioner and the cabinet system. The electrical contact is located, for example, in the upper receiving space or in an intermediate layer (e.g., in the form of a board) between the upper and lower receiving spaces.

One configuration of the cabinet system provides that at least the upper receiving space comprises at least one air guiding device for guiding and that the upper receiving space is configured such that the air conditioner is reversibly contacted with the air guiding device by a completed insertion into the upper receiving space. The air guided in the air guiding device is preferably outside air. In this configuration, contacting between the air conditioner and a structure for guiding air already takes place by inserting the air conditioner into the upper receiving space. This thus additionally simplifies the assembly. In one configuration, the air guided by the air guiding device is outside air, which in particular is sucked in through the floor of the vehicle and blown out through the roof of the vehicle. In one configuration, the air conditioner has a downward air guiding so that there is a connection to the lower receiving space via the corresponding air guiding device. From the lower receiving space, there is then a further air guiding connection to the exterior space outside the space to be cooled, i.e. outside the vehicle.

One configuration of the cabinet system includes that the air guiding device consists at least partially of an opening in a rear wall of the cabinet system. In this configuration, the cabinet system has at least one side wall or two side walls and one rear wall. An opening for the air guiding device is located in the rear wall.

In an alternative configuration, it is provided that the air guiding device consists at least partially of an opening in a wall of the vehicle serving as a rear wall of the cabinet system. Therefore, in this configuration, one side wall or two side walls are provided on an inner wall of the vehicle, which thus forms a rear wall of the cabinet system. An opening for the air guiding device is located in this vehicle wall.

According to one configuration, it is provided that the air guiding device includes a connection in a region of the bottom surface and/or in a region of an upper end surface of the cabinet system. Thus, according to one configuration, it is provided that outside air is sucked at the bottom of the lower receiving space and blown out via the roof of the vehicle and therefore also in the region of the upper end surface of the cabinet system.

In one alternative and/or complementary configuration, the air guiding device is connected to parts of the vehicle which form the bottom and/or the upper end surface of the cabinet system. It is thus provided that the air guiding device comprises a connection in a part of the vehicle forming a region of the bottom surface of the cabinet system and/or in a part of the vehicle forming a region of an upper end surface of the cabinet system.

One configuration of the cabinet system provides that the air guiding device is contacted with the upper receiving space and with the lower receiving space. In this configuration, the air conditioner in the upper receiving space and a device in the lower receiving space can thus use the same structure for guiding air, such as outside air, or for expelling heat to the outside area. This is advantageous, for example, if a refrigerator is arranged in the lower receiving space.

One configuration of the cabinet system includes that dimensions of the lower receiving space correspond to one of a plurality of predetermined groups of dimensional values. Alternatively or additionally, one configuration provides that dimensions of the upper receiving space correspond to one of a plurality of predetermined groups of dimensional values. Thus, the two aforementioned configurations effectively provide a plurality of fixed predetermined basic dimensions for the receiving spaces.

One configuration of the cabinet system provides that a condensate removal device is provided and that the condensate removal device is connected to the upper receiving space. During operation of the air conditioner, condensate generally accumulates due to the humidity of the air and is guided here through the cabinet system to a condensate removal device. The condensate removal device preferably allows the condensate to be removed, for example by opening a valve for draining. The condensate first collects below the evaporator of the air conditioner. Then the condensate is guided through the condensate removal device, for example through a hose or a channel, to the lower receiving space and from there to the bottom of the cabinet system or the vehicle. Alternatively or additionally, the condensate is discharged through air openings (preferably those opening onto the outside air condenser) through a side or rear wall of the cabinet system. Further, the condensate in the air conditioner can be routed from the evaporator to the condenser and then discharged through the air guide of the condenser.

One configuration of the cabinet system includes that there is an electrical connection between a power supply opening into the lower receiving space and the electrical contacting device. In this configuration, the lower receiving space has a power supply which is guided into the upper receiving space to the electrical contacting device. Therefore, only the connection—and associated wiring—to the lower receiving space is required in the caravan, in the cabinet system installed there.

One configuration of the cabinet system provides that the lower receiving space is configured for receiving a refrigerator. In this configuration, the dimensioning and stability of the lower receiving space are designed for a refrigerator.

One configuration of the cabinet system includes that the electrical contacting device is adapted to be electrically contacted with an electrical interface of the air conditioner by a sliding or plug-in connection.

The air conditioner for the cabinet system preferably comprises at least one air intake opening and at least one air exhaust opening, wherein the air conditioner is configured to be applied in a vehicle, and wherein the air intake opening and the air exhaust opening are arranged in a front area of the air conditioner. The two air openings (air intake opening and air exhaust opening) here refer to the supply and exhaust of the room air. As a result of the positioning in the front area, no further modifications need to be made, so that, for example, the air distributor usual in the prior art is not required, either. For example, the air conditioner can project beyond the cabinet system so that the front area is thus the projecting section. The air openings would preferably be arranged laterally. In an alternative configuration, the air conditioner is flush with the cabinet system. In this case, the air conditioner has a front side on which the air openings are located.

According to one configuration, it is provided that the air conditioner has an operating device, and that the operating device is arranged in the front area. Therefore, the operating device is also arranged either laterally at a protruding portion or on the front side.

One configuration provides that the air conditioner comprises an electrical interface for receiving electrical power and/or for communicating data. Preferably, this interface is configured to be connectable to the electrical contacting device of the cabinet system, more specifically by inserting the air conditioner into the upper receiving space. This is provided by the next configuration.

According to one configuration, it is provided that the electrical interface is adapted to be electrically contacted with an associated electrical contacting device by a sliding or plug-in connection.

One configuration provides that the air conditioner is dimensioned and has a weight such that the air conditioner can be manipulated by a person for insertion into a location for fixation. In this configuration, the air conditioner has dimensions and is of such a weight that it can be lifted by a person and can also be inserted into a cabinet system, preferably into the upper receiving space of the cabinet system according to example embodiments. The assembly is thus simplified.

### BRIEF DESCRIPTION OF THE DRAWINGS

In detail, there is a multitude of possibilities for designing and further developing the cabinet system according to example embodiments. For this purpose, reference is made on the one hand to the claims subordinate to the independent claim, and on the other hand to the following description of example embodiments in conjunction with the drawing, in which:

FIG. 1: shows a schematic representation of a vehicle with a cabinet system,

FIG. 2: shows a top view of a schematic cabinet system, and

FIG. 3: shows a schematic front view of an air conditioner.

### DETAILED DESCRIPTION OF EXAMPLE EMBODIMENTS

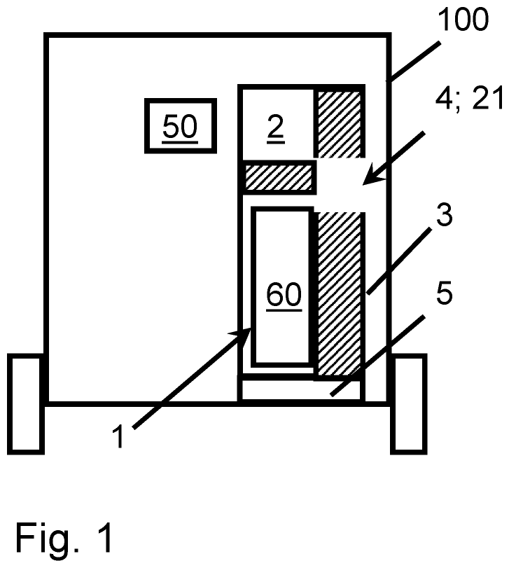

FIG. 1 schematically shows a vehicle 100, which is here a caravan. Alternatively, the vehicle is a mobile home or generally a type of caravan.

A cabinet system according to example embodiments is installed in the vehicle 100. The cabinet system comprises at least a lower receiving space 1 and an upper receiving space 2. A refrigerator 60 is located in the lower receiving space 1, and an air conditioner 50 is inserted into the upper receiving space 2. The air conditioner 50 is fixed and contacted by insertion into the upper receiving space 2, so that no further steps are required, for example the attachment of screws or the laying of cables or pipes. The contacting is thus realized simply by inserting it into the upper receiving space 2. The connections produced in this way are reversible, so that the air conditioner 50 can also be removed again simply by pulling it out. A separating layer is indicated here between the two receiving spaces and thus between the air conditioner 2 and the refrigerator 60. Other objects can thus be placed on this separating layer even in the event that no air conditioner 50 is provided. Thus, the upper receiving space 2 can also serve as a storage space.

An opening 4 is provided in the rear wall 3 of the cabinet system for guiding the outside air to which the air conditioner 50 transfers thermal energy when cooling the room air in the vehicle 100. The refrigerator 60 is also connected to this opening 4 to dissipate heat. The opening 4 thus forms part of the air guiding device 21 for guiding air, in particular outside air, originating from the area outside the vehicle 100.

In the configuration shown, a condensate removal device 5 through which condensate from the air conditioner 50 is guided to the floor of the vehicle 100 is located below the lower receiving space 1.

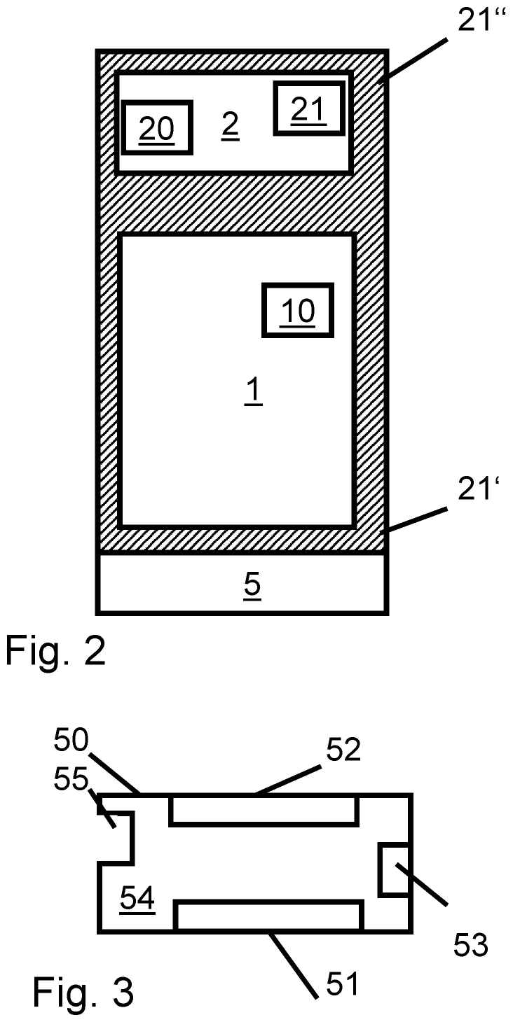

FIG. 2 shows a cabinet system without any components inserted. Indicated are the two side walls, a partition wall or a storage shelf between the upper receiving space 2 and the lower receiving space 1. The condensate removal device 5 is located below the lower receiving space 1, which in an alternative variant—not shown here—is implemented via the guidance of the air.

The electrical contacting device 20 and the air guiding device 21 are indicated in the upper receiving space 2, each of which is designed such that the electrical and air contacting is already carried out by inserting the air conditioner into the upper receiving space 2.

A power supply 10 is indicated in the lower receiving space 1, which is available to the refrigerator to be inserted. Within the cabinet system, the power supply 10 of the lower receiving space 1 is connected to the electrical contacting device 20, so that the air conditioner can thus also receive electrical energy.

The bottom area 21′ and the upper end surface 21″ of the cabinet system are given here by the cabinet system itself. In an alternative configuration, the vehicle serves as the bottom and/or the upper end. The same applies accordingly to the rear wall, which may be formed by the cabinet system itself, for example by a board, or which may be formed by an inner wall of the vehicle.

An air conditioner 50 for the cabinet system is shown in FIG. 3.

The air conditioner 50 sucks air from the room to be cooled through an air intake opening 51, and blows out cold air into the room through the air exhaust opening 52. The thermal energy is thus transferred to the outside air outside the room. The air intake opening 51 and the air exhaust opening 52 are located on the front side 54 of the air conditioner 50. Furthermore, an operating device 53 is located on the front side 54. An electrical interface 55 is indicated, which can be partially designed here as a recess, so that the electrical contacting with the electrical contacting device 20 of the cabinet system is simply achieved by the insertion of the air conditioner 50 into the upper receiving space. Suitable connections for connection with the air guiding device of the cabinet system are located on the rear side of the air conditioner 50—not shown here. The arrangement of the two openings 51, 52 and of the operating device 53 or the electrical interface 55 is purely exemplary here and can also be implemented differently depending on the variants.

Alternatively—in an example not shown here-the installed air conditioner 50 projects from the cabinet system. The air intake opening 51, the air exhaust opening 52 and/or the operating device 53 are then located on at least one of these sides of the front and thus projecting section.

1. A cabinet system for installation in a vehicle, comprising:
a lower receiving space, an upper receiving space and at least one electrical contacting device for providing electrical power and/or for data communication,
wherein the upper receiving space is configured such that an air conditioner can be reversibly inserted into the upper receiving space, and
wherein the upper receiving space is configured such that the air conditioner is mechanically reversibly fixed in the upper receiving space by a completed insertion into the upper receiving space and is reversibly contacted with the electrical contacting device.

2. The cabinet system according to claim 1,
wherein at least the upper receiving space comprises at least one air guiding device for guiding outside air, and
wherein the upper receiving space is configured such that the air conditioner is reversibly contacted with the air guiding device by a completed insertion into the upper receiving space.

3. The cabinet system according to claim 2,
wherein the air guiding device consists at least partially of an opening in a rear wall of the cabinet system.

4. The cabinet system according to claim 2,
wherein the air guiding device consists at least partially of an opening in a wall of the vehicle serving as a rear wall of the cabinet system.

5. The cabinet system according to claim 2,
wherein the air guiding device includes a connection in a part of the vehicle forming a region of the bottom surface of the cabinet system and/or in a part of the vehicle forming a region of an upper end surface of the cabinet system.

6. The cabinet system according to claim 1,
wherein a condensate removal device is provided, and
wherein the condensate removal device is connected to the upper receiving space.

7. The cabinet system according to claim 1,
wherein an electrical connection is provided between a power supply opening into the lower receiving space and the electrical contacting device.

8. The cabinet system according to claim 1,
wherein the electrical contacting device is adapted to be electrically contacted with an electrical interface of the air conditioner by a sliding or plug-in connection.
